(19) United States
(12) Patent Application Publication
(10) Pub. No.: US 2016/0257854 A1
(43) Pub. Date: Sep. 8, 2016

(54) POLISHING COMPOSITION AND POLISHING PROCESSING METHOD USING SAME

(71) Applicant: NORITAKE CO., LIMITED, Nagoya-shi, Aichi (JP)

(72) Inventors: Wataru OMORI, Nagoya-shi (JP); Makoto SATO, Nagoya-shi (JP); Yasunori ANDO, Nagoya-shi (JP)

(73) Assignee: NORITAKE CO., LIMITED, Nagoya-shi, Aichi (JP)

(21) Appl. No.: 15/029,037

(22) PCT Filed: Aug. 12, 2014
(86) PCT No.: PCT/JP2014/071343

§ 371 Date: Apr. 13, 2016

(30) Foreign Application Priority Data
Oct. 22, 2013 (JP) 2013-219631

(51) Int. Cl. C09G 1/02; B24B 37/24

(52) U.S. Cl. CPC C09G 1/02; B24B 37/24

(57) ABSTRACT

A polishing composition contains polishing particles and a polishing liquid used in polishing processing for smoothing a (0001)Si plane of a SiC single crystal used as an object to be polished, the polishing liquid is an oxidizing polishing liquid, and a relationship between pH of the polishing composition and an off-angle of the (0001)Si plane of the SiC single crystal is located within a range surrounded by four straight lines represented by following equations (1), (2), (3), and (4) in two-dimensional x-y coordinates where the off-angle (°) and the pH of the polishing composition are indicated by x and y, respectively: y=4 (1); y=3 (2); x=0 (3); and x=8 (4).

### TECHNICAL FIELD

The present invention relates to a polishing composition containing polishing particles and polishing liquid used in polishing processing for smoothing a surface of a SiC single crystal that is an object to be polished, and more particularly to a polishing composition and a polishing processing method using the same enabling processing of an object to be polished made of a SiC single crystal with relatively high efficiency while maintaining high processing accuracy during the polishing processing.

### BACKGROUND ART

A SiC single crystal has excellent electrical properties and is therefore expected to be used as a substrate for a power semiconductor device, for example. However, because of the hardness next to that of diamond and CBN, SiC has a problem that the processing efficiency is extremely difficult to improve. Thus, as in the case of a polishing composition containing polishing particles and polishing liquid of Patent Document 1, it is attempted in, for example, final polishing processing of a single-crystal SiC substrate, to increase the processing efficiency through a synergetic effect between chemical action of the polishing liquid and mechanical action of the polishing particles while maintaining high processing accuracy.

### PRIOR ART DOCUMENT

### Patent Document

Patent Document 1: Japanese Laid-Open Patent Publication No. 2008-68390

### SUMMARY OF THE INVENTION

### Problem to be Solved by the Invention

However, the polishing composition containing polishing particles and polishing liquid as described above has a problem that it is difficult to process an object to be polished made of a SiC single crystal in polishing processing using the polishing composition with higher efficiency as compared to the conventional compositions while maintaining high processing accuracy.

The present invention was conceived in view of the situations and it is therefore an object of the present invention to provide a polishing composition for processing an object to be polished made of a SiC single crystal with higher efficiency as compared to the conventional compositions while maintaining high processing accuracy.

### Means for Solving the Problem

As a result of various analyses and studies, the present inventors found out the following fact. Specifically, the present inventors found out an unexpected fact that at the time of polishing processing of a (0001)Si plane or a (000-1)C plane of a SiC single crystal used as an object to be polished, a relationship between a pH value of an oxidizing polishing liquid in the polishing composition and an off-angle θoff (°) of the (0001)Si plane or the (000-1)C plane of the SiC single crystal can be set within a predetermined range so as to perform polishing processing of the object to be polished made of the SiC single crystal with the polishing composition with higher efficiency as compared to the conventional compositions while maintaining high processing accuracy. The present invention was conceived based on such knowledge.

To achieve the above object, a first aspect of the invention provides a polishing composition containing (a) polishing particles and a polishing liquid used in polishing processing for smoothing a (0001)Si plane of a SiC single crystal used as an object to be polished, wherein (b) the polishing liquid is an oxidizing polishing liquid, and a relationship between pH of the polishing composition and an off-angle of the (0001)Si plane of the SiC single crystal is located within a range surrounded by four straight lines represented by following equations. (1), (2), (3), and (4) in two-dimensional x-y coordinates where the off-angle (°) and the pH of the polishing composition are indicated by x and y, respectively:

y=4 (1);

y=3 (2);

x=0 (3); and

x=8 (4).

To achieve the above object, a second aspect of the invention provides a polishing composition containing (a) polishing particles and a polishing liquid used in polishing processing for smoothing a (000-1)C plane of a SiC single crystal used as an object to be polished, wherein (b) the polishing liquid is an oxidizing polishing liquid, and a relationship between pH of the polishing composition and an off-angle of the (000-1)C plane of the SiC single crystal is located within a range surrounded by four straight lines represented by following equations (1), (5), (3), and (4) in two-dimensional x-y coordinates where the off-angle (°) and the pH of the polishing composition are indicated by x and y, respectively:

y=4 (1);

y=0.25x+1(x≦4), y=2(4≦x) (5);

x=0 (3); and

x=8 (4).

### Effects of the Invention

According to the polishing composition in the first aspect of the invention, the polishing liquid is an oxidizing polishing liquid, and the relationship between the pH of the polishing composition and the off-angle of the SiC single crystal used as the object to be polished relative to the (0001)Si plane is located within the range surrounded by the four straight lines represented by equations (1), (2), (3), and (4) in the two-dimensional x-y coordinates where the off-angle (°) and the pH of the polishing composition are indicated by x and y. This polishing composition enables the processing of the surface of the SiC single crystal used as the object to be polished with higher efficiency as compared to the conventional slurries while maintaining high processing accuracy.

According to the polishing composition in the second aspect of the invention, the polishing liquid is an oxidizing polishing liquid, and the relationship between the pH of the polishing composition and the off-angle of the SiC single crystal used as the object to be polished relative to the (000-1)C plane is located within the range surrounded by the four straight lines represented by equations (1), (5), (3), and (4) in the two-dimensional x-y coordinates where the off-angle (°) and the pH of the polishing composition are indicated by x and y. This polishing composition enables the processing of the surface of the SiC single crystal used as the object to be polished with higher efficiency as compared to the conventional slurries while maintaining high processing accuracy.

In one preferred form of the invention, oxidation-reduction potential of the oxidizing polishing liquid is located within a range between two straight lines represented by following equations (6) and (7) in two-dimensional y-z coordinates where the oxidation-reduction potential (mV) of the polishing liquid is indicated by z. This polishing composition enables the processing of the surface of the SiC single crystal used as the object to be polished with higher efficiency.

z=−75y+1454 (6)

z=−75y+1406 (7)

In another preferred form of the invention, potassium permanganate or potassium thiosulfate is added as a regulator for an oxidation-reduction potential of the oxidizing polishing liquid. Therefore, by adding the potassium permanganate or the potassium thiosulfate, the oxidation-reduction potential of the oxidizing polishing liquid can preferably be adjusted into the range between the two straight lines represented by equations (6) and (7) described above, for example.

In a further preferred form of the invention, the polishing particles contain at least one of silica, ceria, alumina, zirconia, titania, manganese oxide, barium carbonate, chromium oxide, and iron oxide. Therefore, the polishing composition containing the polishing particles enables the processing of the surface of the SiC single crystal used as the object to be polished with higher efficiency while maintaining high processing accuracy.

In a yet further preferred form of the invention, the polishing composition is used in a polishing processing method of performing polishing processing of a SiC single crystal material by using the polishing composition. Therefore, the polishing processing method enables polishing of the SiC single crystal material with relatively high efficiency while maintaining high processing accuracy.

### BRIEF DESCRIPTION OF THE DRAWINGS

FIG. 1 is a schematic for explaining a general configuration of a polishing system using a polishing slurry according to an embodiment of the present invention.

FIG. 2 is a diagram of results of polishing efficiency (nm/h) and surface roughness Ra (nm) of substrates to be polished (work pieces) having the off-angle of 0° relative to a (0001)Si plane polished with polishing slurries indicated by Test Nos. 1 to 25 in the polishing system shown in FIG. 1.

FIG. 3 is a diagram of the oxidation-reduction potential and pH of the polishing slurries of Test Nos. 1 to 25 shown in FIG. 2 each indicated by a point in two-dimensional y-z coordinates having the y-axis indicative of the pH of the polishing slurries and the z-axis indicative of the oxidation-reduction potential (mV) of the polishing slurries.

FIG. 4 is an enlarged view of a portion around respective points of Test Nos. 5, 6, 7, 8, 14, and 15 shown in FIG. 3, and the points being indicative of the relationship between the oxidation-reduction potential and the pH of the polishing slurries.

FIG. 5 is a diagram of results of polishing efficiency (nm/h) and surface roughness Ra (nm) of substrates to be polished having the off-angles of 0°, 4°, and 8° relative to a (0001)Si plane polished with polishing slurries indicated by Test Nos. 1 to 3, 5, 7, 10, and 26 to 37 in the polishing system shown in FIG. 1.

FIG. 6 is a diagram of the pH and polishing efficiency of the polishing slurries of Test Nos. 1 to 3, 5, 7, 10, and 26 to 37 shown in FIG. 5 each indicated by points in two-dimensional coordinates having the horizontal axis indicative of the pH of the polishing slurries and the vertical axis indicative of the polishing efficiency (nm/h).

FIG. 7 is a diagram of the pH of the polishing slurries and the off-angle θoff of the substrates to be polished of Test Nos. 5, 7, 29, 30, 35, and 36 shown in FIG. 6 each indicated by points in two-dimensional x-y coordinates having the x-axis indicative of the off-angles θoff of the substrates to be polished relative to the (0001)Si plane and the y-axis indicative of the pH of the polishing slurries.

FIG. 8 is a diagram of results of polishing efficiency (nm/h) and surface roughness Ra (nm) of substrates to be polished having the off-angles of 0°, 4°, and 8° relative to a (000-1)C plane polished with polishing slurries indicated by Test Nos. 38 to 55 in the polishing system shown in FIG. 1.

FIG. 9 is a diagram of the pH and polishing efficiency of the polishing slurries of Test Nos. 38 to 55 shown in FIG. 8 each indicated by points in two-dimensional coordinates having the horizontal axis indicative of the pH of the polishing slurries and the vertical axis indicative of the polishing efficiency (nm/h).

FIG. 10 is a diagram of the pH of the polishing slurries and the off-angle θoff of the substrates to be polished of Test Nos. 39 to 42, 46 to 48, and 52 to 54 shown in FIG. 9 each indicated by points in two-dimensional x-y coordinates having the x-axis indicative of the off-angles θoff of the substrates to be polished relative to the (000-1)C plane and the y-axis indicative of the pH of the polishing slurries.

FIG. 11 is a diagram of results of polishing efficiency (nm/h) and surface roughness Ra (nm) of substrates to be polished having the off-angle of 0° relative to a (0001)Si plane polished with polishing slurries containing ceria abrasive grains indicated by Test Nos. 56 to 61 in the polishing system shown in FIG. 1.

FIG. 12 is a diagram of the pH and polishing efficiency of the polishing slurries of Test Nos. 56 to 61 shown in FIG. 11 each indicated by a point in two-dimensional coordinates having the horizontal axis indicative of the pH of the polishing slurries and the vertical axis indicative of the polishing efficiency (nm/h).

### MODE FOR CARRYING OUT THE INVENTION

An example of the present invention will now be described in detail with reference to the drawings. In the following example, the figures are simplified or deformed as needed and portions are not necessarily precisely shown in terms of dimension ratio, shape, etc.

### EXAMPLE 1

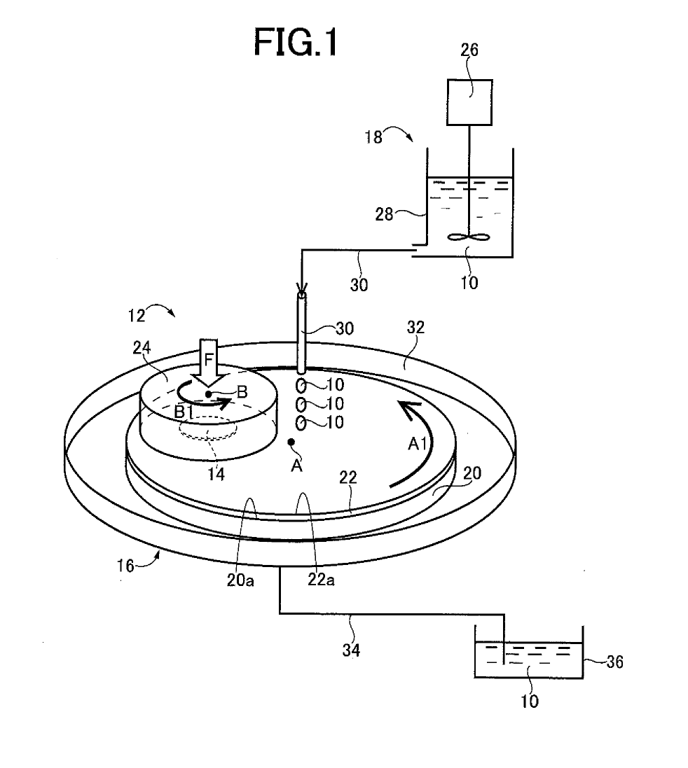

FIG. 1 is a schematic for explaining a general configuration of a polishing system 12 using a polishing slurry (polishing composition) 10 containing polishing particles and polishing liquid according to an embodiment of the present invention. The polishing system 12 includes a polisher 16 polishing and smoothing a surface of a substrate to be polished (object to be polished) 14 made of a SiC single crystal that is a work piece with polishing particles made of, for example, silica (SiO₂) abrasive grains contained in the polishing slurry 10, and a slurry supply apparatus 18 supplying the polishing slurry 10 to the polisher 16, so as to process and discard the polishing slurry 10 used in the polisher 16.

As shown in FIG. 1, the polisher 16 includes a disk-shaped table 20 rotationally driven around a point A in the direction of an arrow A1, a disk-shaped polishing pad 22 made of, for example, foamed polyurethane affixed to a top surface 20a of the table 20, and a carrier 24 holding and allowing a disk-shaped substrate to be polished 14 to rotate around its own axis in sliding contact with a polishing surface 22a that is a top surface of the polishing pad 22, and the polisher 16 polishes and smooths the substrate to be polished 14 with the polishing particles contained in the polishing slurry 10 supplied onto the polishing pad 22 by the slurry supply apparatus 18. The carrier 24 is rotationally driven around a point B in the direction of an arrow B1 while being pressed in the direction of an arrow F and, as the carrier 24 is rotationally driven in the direction of the arrow B1 while being pressed in the direction of the arrow F, the substrate to be polished 14 is held and allowed to rotate around its own axis in sliding contact with the polishing pad 22.

As shown in FIG. 1, the slurry supply apparatus 18 includes a first pipe line 30 supplying the polishing slurry 10 in a first storage tank 28 having an agitator 26 to the polishing surface 22a of the polishing pad 22, a receiving cover 32 receiving the polishing slurry 10 dripping down from the polishing pad 22, and a second storage tank 36 storing the polishing slurry 10 received by the receiving cover 32 through a second pipe line 34 connected to the receiving cover 32, so that the polishing slurry 10 stored in the second storage tank 36 is processed and discarded.

The substrate to be polished 14 polished by the polisher 16 in the polishing system 12 of this example is, for example, a disk-shaped disk member acquired by slicing of a SiC single crystal ingot with a hexagonal crystal structure on a (0001)Si plane or a (000-1)C plane indicated by a so-called Miller index followed by grinding processing, and is polished by the polisher 16 so as to smooth a ground surface subjected to the slicing and the grinding processing, i.e., the (0001)Si plane or the (000-1)C plane. The substrate to be polished 14 is obtained by slicing the SiC single crystal ingot within a predetermined range of an off-angle θoff, i.e., a range of 0 to 8°. The off-angle θoff is an angle (°) of slicing-out relative to the (0001)Si plane or the (000-1)C plane for acquiring the substrate to be polished 14 from the SiC single crystal ingot, i.e., an inclination angle of a cut surface of the substrate to be polished 14 relative to the (0001)Si plane or the (000-1)C plane.

When the substrate to be polished 14 acquired by slicing the SiC single crystal ingot on the (0001)Si plane is used in the polishing system 12 of this example, a relationship of the pH of the polishing slurry 10 and the off angle θoff of the substrate to be polished 14 is set within a range surrounded by four straight lines represented by following equations (1), (2), (3), and (4) in two-dimensional x-y coordinates where the off-angle θoff and the pH of the polishing slurry 10 are indicated by x and y, respectively.

y=4 (1)

y=3 (2)

x=0 (3)

x=8 (4)

When the substrate to be polished 14 acquired by slicing the SiC single crystal ingot on the (000-1)C plane is used in the polishing system 12 of this example, a relationship of the pH of the polishing slurry 10 and the off-angle θoff of the substrate to be polished 14 is set within a range surrounded by four straight lines represented by equations (1), (5), (3), and (4) in two-dimensional x-y coordinates where the off-angle θoff and the pH of the polishing slurry 10 are indicated by x and y, respectively.

y=0.25x+1(x≦4), y=2(4≦x) (5)

The polishing liquid of the polishing slurry 10 in the polishing system 12 of this example is an oxidizing polishing liquid, and an oxidation-reduction potential (ORP) of the oxidizing polishing liquid is set within a range between two straight lines represented by following equations (6) and (7) in two-dimensional y-z coordinates where the oxidation-reduction potential (mV) of the oxidizing polishing liquid is indicated by z.

z=−75y+1454 (6)

z=−75y+1406 (7)

To adjust the pH of the polishing slurry 10 into the range between the two straight lines represented by equations (1) and (2) or equations (1) and (5), for example, a pH regulator such as a sulfuric acid (H₂SO₄) solution and a potassium hydroxide (KOH) solution is appropriately added to the polishing slurry 10. To adjust the oxidation-reduction potential (mV) of the polishing liquid of the polishing slurry 10 into the range between two straight lines represented by equations (6) and (7), for example, an oxidation-reduction potential regulator such as a potassium permanganate (KMnO₄) solution and a potassium thiosulfate (K₂S₂O₃) solution is appropriately added to the polishing slurry 10.

When the substrate to be polished 14 made of a SiC single crystal is subjected to polishing processing with the polishing slurry 10, the polishing system 12 configured as described can process a surface of the SiC single crystal used as the substrate to be polished 14 with higher efficiency while maintaining high processing accuracy.

### [Experiment I]

An experiment I conducted by the present inventors will hereinafter be described. In the experiment I, an apparatus having substantially the same configuration as the polishing system 12 as shown in FIG. 1 is used for polishing the substrate to be polished 14 having the off-angle θoff of 0° relative to the (0001)Si plane of a 4H-SiC single crystal by using the polishing slurries 10 containing, for example, silica (SiO₂) abrasive grains with values of pH and oxidation-reduction potential (ORP) respectively adjusted, so as to verify the effect of differences in values of pH and oxidation-reduction potential adjusted in the polishing slurries 10 on the substrate to be polished 14.

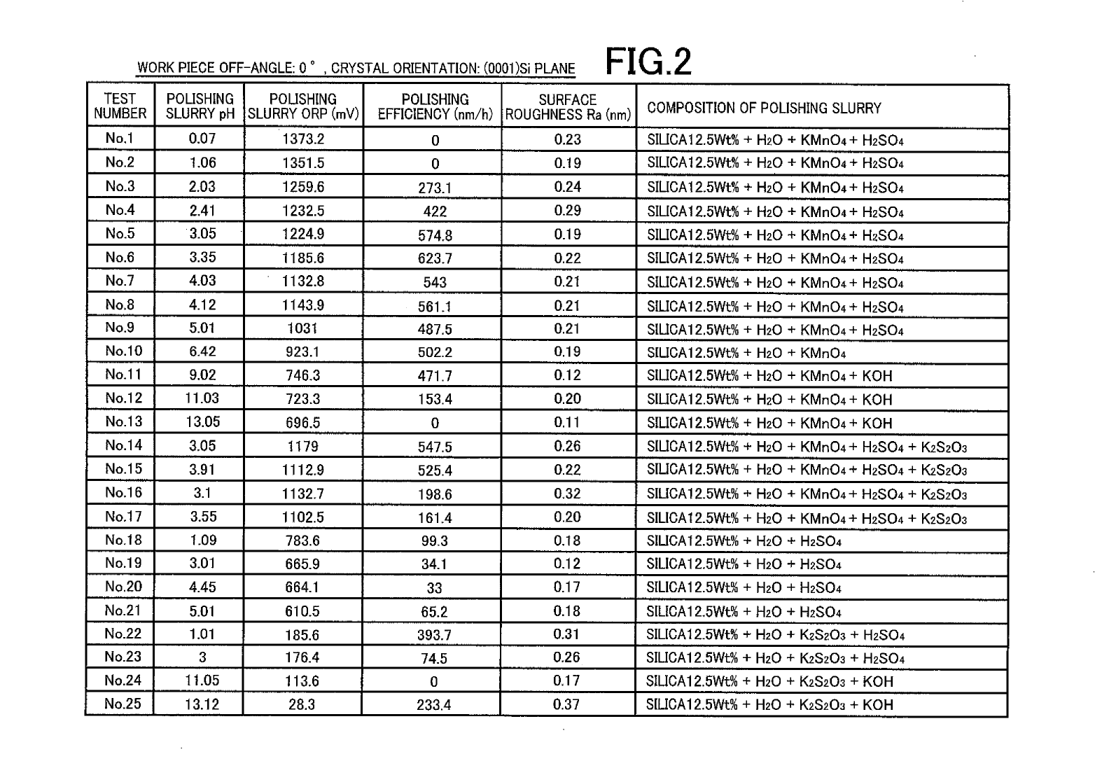

In the experiment I, first, 25 types of the polishing slurries 10, i.e., the polishing slurries 10 of Test Nos. 1 to 25 were produced with the pH and the oxidation-reduction potential (ORP) adjusted to respective values as shown in FIG. 2, and a polishing test was conducted for a predetermined time with polishing processing conditions described in following Table 1. In the polishing slurries 10 each used in the experiment I, the pH of the polishing slurry 10 was adjusted by using pH regulators, for example, a sulfuric acid (H₂SO₄) solution (concentration: 1 mol/L) and a potassium hydroxide (KOH) solution (concentration: 1 mol/L) while the oxidation-reduction potential (ORP) of the polishing slurry 10 was adjusted by using oxidation-reduction potential regulators, for example, a potassium permanganate (KMnO₄) solution (concentration: 0.1 mol/L) used as an oxidizing agent for increasing the ORP and a potassium thiosulfate (K₂S₂O₃) solution (concentration: 0.1 mol/L) used as a reducing agent for decreasing the ORP and, as described in “Composition of Polishing Slurry” shown in FIG. 2, the pH regulators and the oxidation-reduction potential regulators were added to the polishing slurries 10 as needed. The silica abrasive grains used as the polishing particles contained in the polishing slurries 10 have an average particle diameter of about 800 nm. The average particle diameter of the silica abrasive grains was obtained by using Mastersizer 2000 of Malvern Instruments with a laser diffraction method. The pH of the polishing slurries 10 was obtained by using CyberScan pH110 and the electrode ECFC7352901B of EUTECH. The oxidation-reduction potential (ORP) of the polishing slurries 10 was obtained by using CyberScan pH110 and the electrode ECFC7960101B of EUTECH. A “substrate to be polished” described in the polishing processing conditions of Table 1 is the substrate to be polished 14 having a mirror surface polished in advance with colloidal silica, for example.

[Table 1]

Polisher: EJW-380 (manufactured by Engis)

Polishing pad: IC 1000 (manufactured by Nitta Haas Incorporated)

Rotation speed of polishing pad (table): 60 rpm

Substrate to be polished: 4H-SiC

Shape of substrate to be polished: φ2 inches

Rotation speed of substrate to be polished: 56 rpm

Load (load of pressing the carrier in the direction of the arrow F): 50.8 kPa

Supply amount of polishing slurry: 10 ml/min

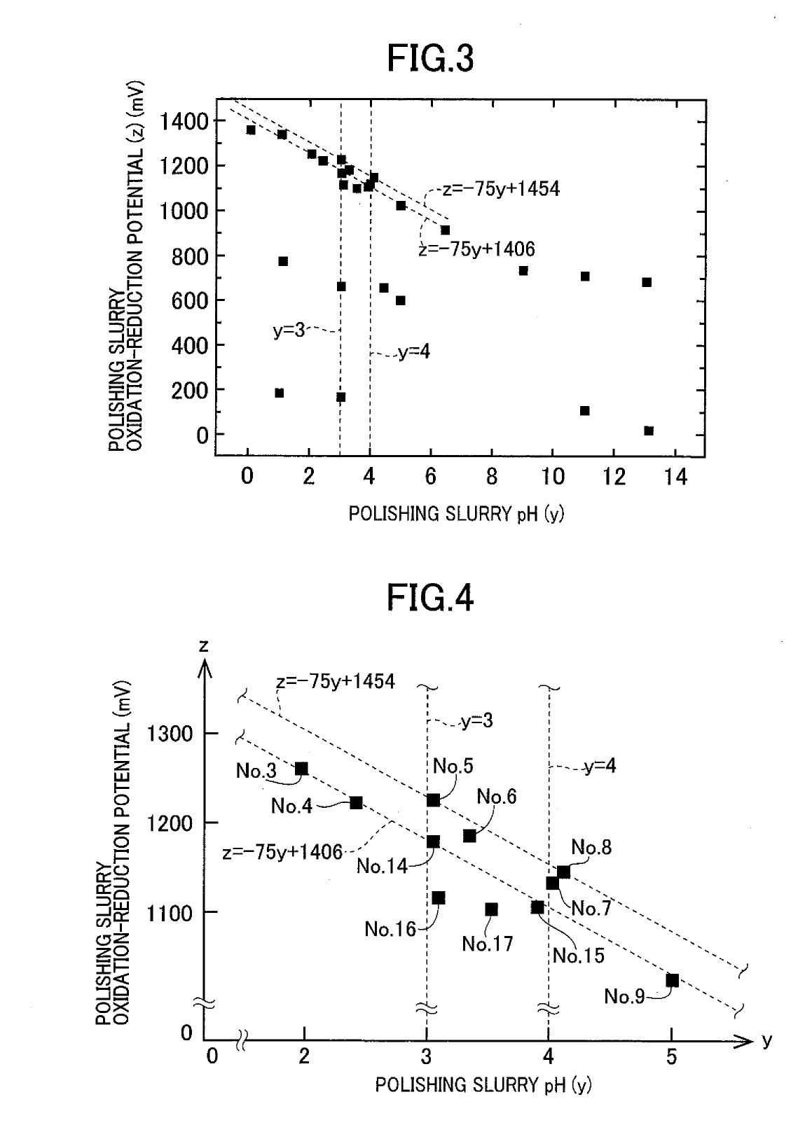

The results of the experiment I will hereinafter be described with reference to FIGS. 2 to 4. “Polishing efficiency (nm/h)” described in FIG. 2 is a value indicative of a polishing amount per unit time of the substrate to be polished 14 after the polishing test and is a value calculated based on a difference in weight of the substrate to be polished 14 between before and after the polishing. “Surface roughness Ra (nm)” described in FIG. 2 is a value indicative of surface roughness of the substrate to be polished 14 after the polishing test, and the surface roughness Ra (nm) of the substrate to be polished 14 was measured by using an interference microscope (BW-A manufactured by Nikon). FIG. 3 is a diagram of the oxidation-reduction potential and pH of the polishing slurries 10 of Test Nos. 1 to 25 shown in FIG. 2 each indicated by a point of a black square mark in two-dimensional y-z coordinates having the y-axis (horizontal axis of FIG. 3) indicative of the pH of the polishing slurries 10 and the z-axis (vertical axis of FIG. 3) indicative of the oxidation-reduction potential (mV) of the polishing slurries 10. FIG. 4 is an enlarged view of a portion around respective points of Test Nos. 5, 6, 7, 8, 14, and 15 shown in FIG. 3.

As shown in the results of the experiment I of FIG. 2, among Test Nos. 1 to 25, the polishing slurries 10 of Test Nos. 5, 6, 7, 8, 14, and 15 resulted in processing of the substrate to be polished 14 with higher efficiency while maintaining relatively high processing accuracy. In the experiment I, the relatively high processing accuracy means that the surface roughness Ra of the substrate to be polished 14 after the polishing processing is about 0.3 nm or equal to or less than 0.3 nm, and the higher efficiency means that the polishing efficiency after the polishing processing is higher than the polishing efficiency (502.2 nm/h) of the polishing slurry 10 of Test No. 10 having the pH of 6.42 and the oxidation-reduction potential of 923.1 (mV) acquired by increasing the oxidation-reduction potential with a potassium permanganate solution without adjustment of the pH.

As shown in FIGS. 3 and 4, with regard to the points indicative of the oxidation-reduction potential and pH of the polishing slurries 10 of Test Nos. 5, 6, 7, 8, 14, and 15 resulting in the processing of the substrate to be polished 14 with higher efficiency while maintaining relatively high processing accuracy, the relationships between the pH of the polishing slurries 10 and the oxidation-reduction potential of the polishing slurries 10 are located within, or in the vicinity of, a range surrounded by four straight lines represented by y=4, y=3, z=−75y+1454, and z=−75y+1406 in the two-dimensional y-z coordinates of the pH of the polishing slurries 10 and the oxidation-reduction potential (mV) of the polishing slurries 10 indicated by y and z, respectively. Additionally, the polishing slurries 10 of Test Nos. 5, 6, 7, 8, 14, and 15 described above have the polishing efficiency (nm/h) improved by about 5 to 25% as compared to the polishing slurry 10 of Test No. 9 without pH adjustment. The four straight lines described above, i.e., y=4, y=3, z=−75y+1454, and z=−75y+1406, are set by the present inventors based on the points indicative of Test Nos. 5, 6, 7, 8, 14, and 15 shown in FIG. 4. For example, the straight line z=−75y+1454 is an equation calculated from two points, i.e., the point of Test No. 5 and the point indicative of Test No. 8 in FIG. 4.

According to the results of the experiment I, the oxidation-reduction potential and pH of the polishing slurries 10 of Test Nos. 5, 6, 7, 8, 14, and 15 are located within, or in the vicinity of, the range surrounded by the four straight lines represented by y=4, y=3, z=−75y+1454, and z=−75y+1406 in the two-dimensional y-z coordinates shown in FIGS. 3 and 4. Therefore, it is considered that the polishing slurry 10 enables processing of the surface of the 4H-SiC single crystal used as the substrate to be polished 14 with higher efficiency while maintaining high processing accuracy, by setting the relationship between the pH and the oxidation-reduction potential of the polishing slurry 10 within the range surrounded by the four straight lines represented by y=4, y=3, z=−75y+1454, and z−75y+1406 in the two-dimensional y-z coordinates of the pH of the polishing slurry 10 and the oxidation-reduction potential (mV) of the polishing slurry 10 indicated by y and z, respectively.

### [Experiment II]

An experiment II conducted by the present inventors will hereinafter be described. In the experiment II, an apparatus having substantially the same configuration as the polishing system 12 as shown in FIG. 1 is used in substantially the same way as the experiment I for polishing the substrates to be polished 14 having the respective different off-angles θoff relative to the (0001)Si plane of the 4H-SiC single crystal by using the polishing slurries 10 containing silica abrasive grains with values of pH and oxidation-reduction potential respectively adjusted, so as to verify the effect of differences in values of the pH adjusted in the polishing slurries 10 and the off-angles θoff (°) of the substrates to be polished 14 on the substrates to be polished 14.

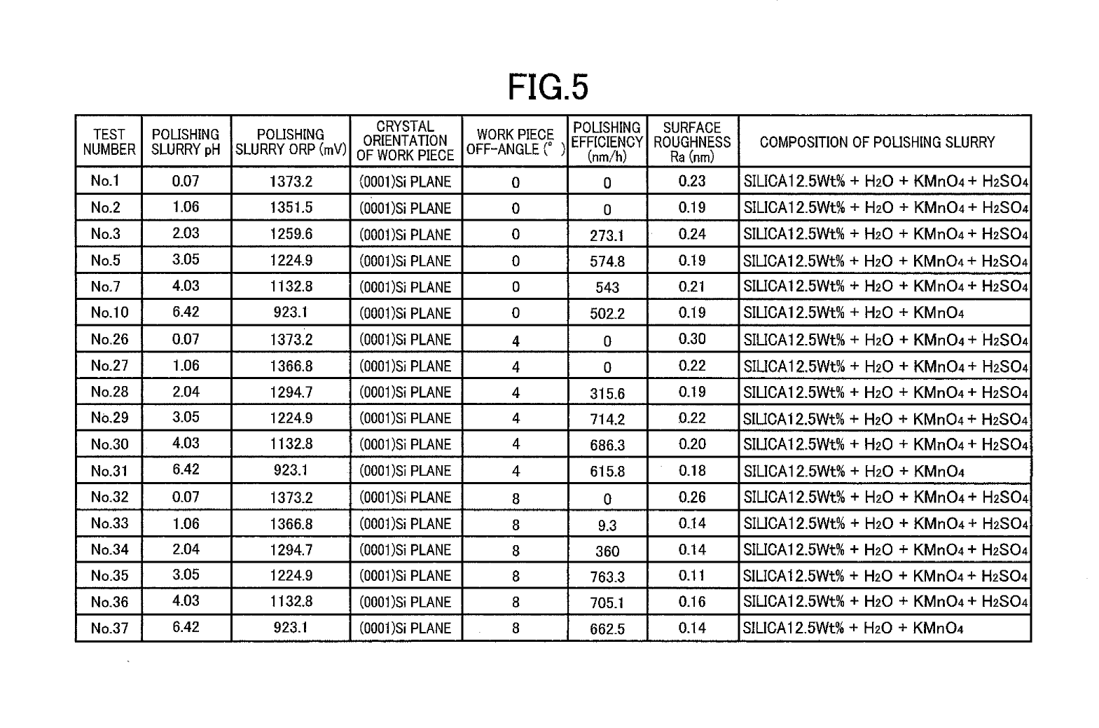

In the experiment II, first, each of the six types of the polishing slurries 10 used in Test Nos. 1, 2, 3, 5, 7, and 10 of the experiment I was used for conducting a polishing test of the substrates to be polished 14 having the respective different off-angles θoff (°), i.e., the substrates to be polished 14 having the off-angles of 0°, 4°, and 8°, for a predetermined time with the polishing processing conditions described in Table 1 described above. It is noted that, as shown in FIG. 5, Test Nos. 26 to 31 represent tests in which the polishing slurries 10 were used for the substrate to be polished 14 having the off-angle θoff of 4° relative to the (0001)Si plane and the polishing slurries 10 in Test Nos. 26 to 31 are common with those in Test Nos. 1 to 3, 5, 7, and 10 respectively, and Test Nos. 32 to 37 represent tests in which the polishing slurries 10 were used for the substrate to be polished 14 having the off-angle θoff of 8° relative to the (0001)Si plane and the polishing slurries 10 in Test Nos. 26 to 31 are common with those in Test Nos. 1 to 3, 5, 7, and 10 respectively.

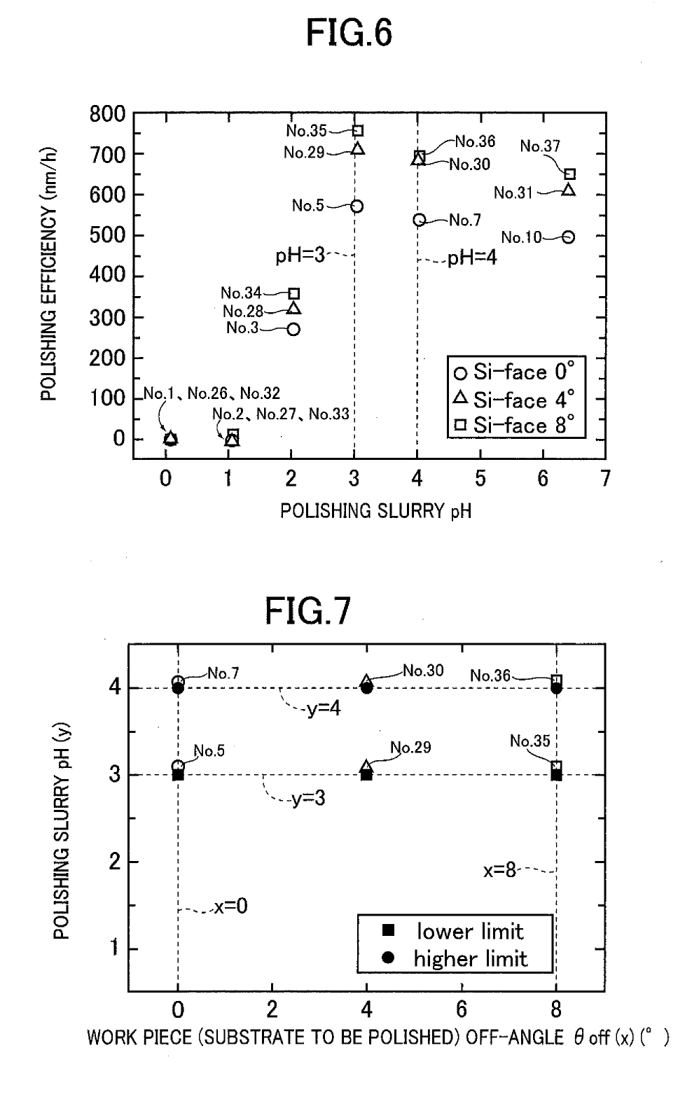

The results of the experiment II will hereinafter be described with reference to FIGS. 5 to 7. FIG. 5 is a diagram of test results of polishing efficiency (nm/h) and surface roughness Ra (nm) from the polishing tests of Test Nos. 1 to 3, 5, 7, 10, and 26 to 37. FIG. 6 is a diagram of the pH and polishing efficiency of the polishing slurries 10 of Test Nos. 1 to 3, 5, 7, 10, and 26 to 37 shown in FIG. 5 each indicated by a point of a circle mark, a triangle mark, or a square mark in two-dimensional coordinates having the horizontal axis indicative of the pH of the polishing slurries 10 and the vertical axis indicative of the polishing efficiency (nm/h). It is noted that the point of the circle mark represents the polishing of the substrate to be polished 14 having the off-angle θoff of 0° relative to the (0001)Si plane, that the point of the triangle mark represents the polishing of the substrate to be polished 14 having the off-angle θoff of 4° relative to the (0001)Si plane, and that the point of the square mark represents the polishing of the substrate to be polished 14 having the off-angle θoff of 8° relative to the (0001)Si plane. FIG. 7 is a diagram of the pH of the polishing slurries 10 and the off-angle θoff (°) of the substrates to be polished 14 of Test Nos. 5, 7, 29, 30, 35, and 36 each indicated by a point of the circle mark, the triangle mark, or the square mark, as defined above, in two-dimensional x-y coordinates having the x-axis (horizontal axis of FIG. 7) indicative of the off-angles θoff (°) of the substrates to be polished (work pieces) 14 relative to the (0001)Si plane and the y-axis (vertical axis of FIG. 7) indicative of the pH of the polishing slurries 10.

As shown in FIGS. 5 and 6 of the results of the experiment II, among Test Nos. 1 to 3, 5, 7, 10, and 26 to 37, the polishing slurries 10 of Test Nos. 5, 7, 29, 30, 35, and 36 resulted in processing of the substrate to be polished 14 with higher efficiency while maintaining relatively high processing accuracy. In the experiment II, the relatively high processing accuracy is the same as that of the experiment I, meaning that the surface roughness Ra of the substrate to be polished 14 after the polishing processing is about 0.3 nm or equal to or less than 0.3 nm. The higher efficiency means that, in the respective cases of using the substrates to be polished 14 having the off-angles θoff of 0°, 4°, and 8° relative to the (0001)Si plane, the polishing efficiency (nm/h) after the polishing processing is higher than the polishing efficiency (nm/h) of the polishing slurries 10 of Test Nos. 10, 31, and 37. Therefore, in the case of using the substrate to be polished 14 having the off-angle θoff of 0° relative to the (0001)Si plane, the higher efficiency means that the polishing efficiency (nm/h) after the polishing processing is higher than the polishing efficiency of 502.2 (nm/h) of the polishing slurry 10 of Test No. 10; in the case of using the substrate to be polished 14 having the off-angle θoff of 4° relative to the (0001)Si plane, the higher efficiency means that the polishing efficiency (nm/h) after the polishing processing is higher than the polishing efficiency of 615.8 (nm/h) of the polishing starry 10 of Test No. 31; and in the case of using the substrate to be polished 14 having the off-angle θoff of 8° relative to the (0001)Si plane, the higher efficiency means that the polishing efficiency (nm/h) after the polishing processing is higher than the polishing efficiency of 662.5 (nm/h) of the polishing slurry 10 of Test No. 37.

As shown in FIG. 7, with regard to the points corresponding to the polishing slurries 10 of Test Nos, 5, 7, 29, 30, 35, and 36 resulting in the processing of the substrate to be polished 14 with higher efficiency while maintaining relatively high processing accuracy, the relationship between the off-angle θoff (°) of the substrate to be polished 14 and the pH of the polishing slurry 10 is located within, or in the vicinity of, a range surrounded by four straight lines represented by y=4, y=3, x=0, and x=8 in the two-dimensional x-y coordinates of the off-angle θoff (°) of the substrate to be polished 14 and the pH of the polishing slurry 10 indicated by x and y, respectively. The four straight lines described above, i.e., y=4, y=3, x=0, and x=8, are determined from the points of black circle marks (higher limit) and the points of black square marks (lower limit) set by the present inventors based on the points corresponding to Test Nos. 5, 7, 29, 30, 35, and 36 shown in FIG. 7. Although not shown, the polishing slurries 10 of Test Nos. 5, 7, 29, 30, 35, and 36 have a relationship between the pH of the polishing slurries 10 and the oxidation-reduction potential (mV) of the polishing slurries 10 located within a range between two straight lines represented by z=−75y+1454 and z=−75y+1406 in the two-dimensional y-z coordinates of the pH of the polishing slurries 10 and the oxidation-reduction potential of the polishing slurries 10 indicated by y and z, respectively.

According to the results of the experiment II, the polishing slurries 10 of Test Nos. 5, 7, 29, 30, 35, and 36 described above are located within, or in the vicinity of, the range surrounded by the four straight lines represented by y=4, y=3, x=0, and x=8 in the two-dimensional x-y coordinates shown in FIG. 7. Therefore, it is considered that the polishing slurry 10 enables processing of the surface of the 4H-SiC single crystal used as the substrate to be polished 14 with higher efficiency while maintaining high processing accuracy, by setting the relationship between the off-angle θoff (°) of the substrate to be polished 14 relative to the (0001)Si plane and the pH of the polishing slurry 10 within the range surrounded by the four straight lines represented by y=4, y=3, x=0, and x=8 in the two-dimensional x-y coordinates of the off-angle θoff (°) relative to the (0001)Si plane and the pH of the polishing slurry 10 indicated by x and y, respectively.

### [Experiment III]

An experiment III conducted by the present inventors will hereinafter be described. In the experiment III, an apparatus having substantially the same configuration as the polishing system 12 as shown in FIG. 1 is used in substantially the same way as the experiment I for polishing the substrates to be polished 14 having the respective different off-angles θoff relative to the (000-1)C plane of the 4H-SiC single crystal by using the polishing slurries 10 containing silica abrasive grains with values of pH and oxidation-reduction potential respectively adjusted, so as to verify the effect of differences in values of the pH adjusted in the polishing slurries 10 and the off-angles θoff (°) of the substrates to be polished 14 on the substrates to be polished 14. The experiment III is different from the experiment II in that the (000-1)C plane of the substrate to be polished 14 made of the 4H-SiC single crystal is polished with the polishing slurry 10, and is substantially the same as the experiment II in terms of the other points. Therefore, the portions of the experiment III substantially the same as the experiment II will not be described.

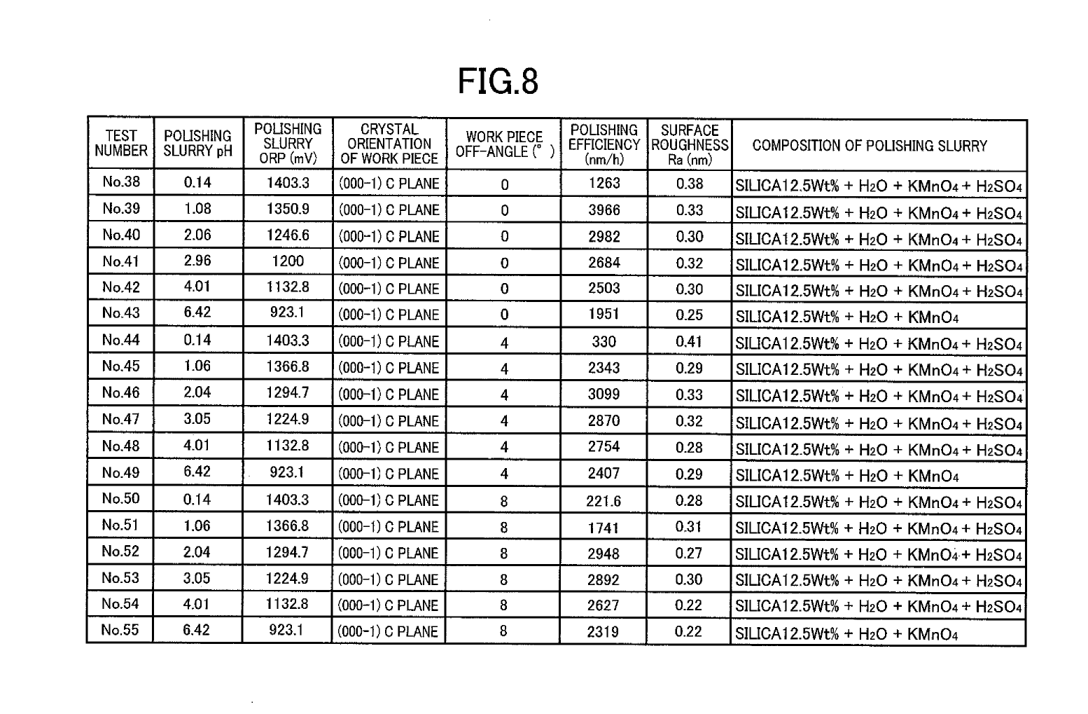

In the experiment III, first, the polishing slurries 10 of Test Nos. 38 to 55 were produced with the pH and the oxidation-reduction potential (ORP) adjusted to respective values as shown in FIG. 8, and each of these polishing slurries 10 was used for conducting a polishing test of the substrates to be polished 14 having the respective different off-angles θoff (°), i.e., the substrates to be polished 14 having the off-angles of 0°, 4°, and 8° relative to the (000-1)C plane, for a predetermined time with the polishing processing conditions described in Table 1 described above.

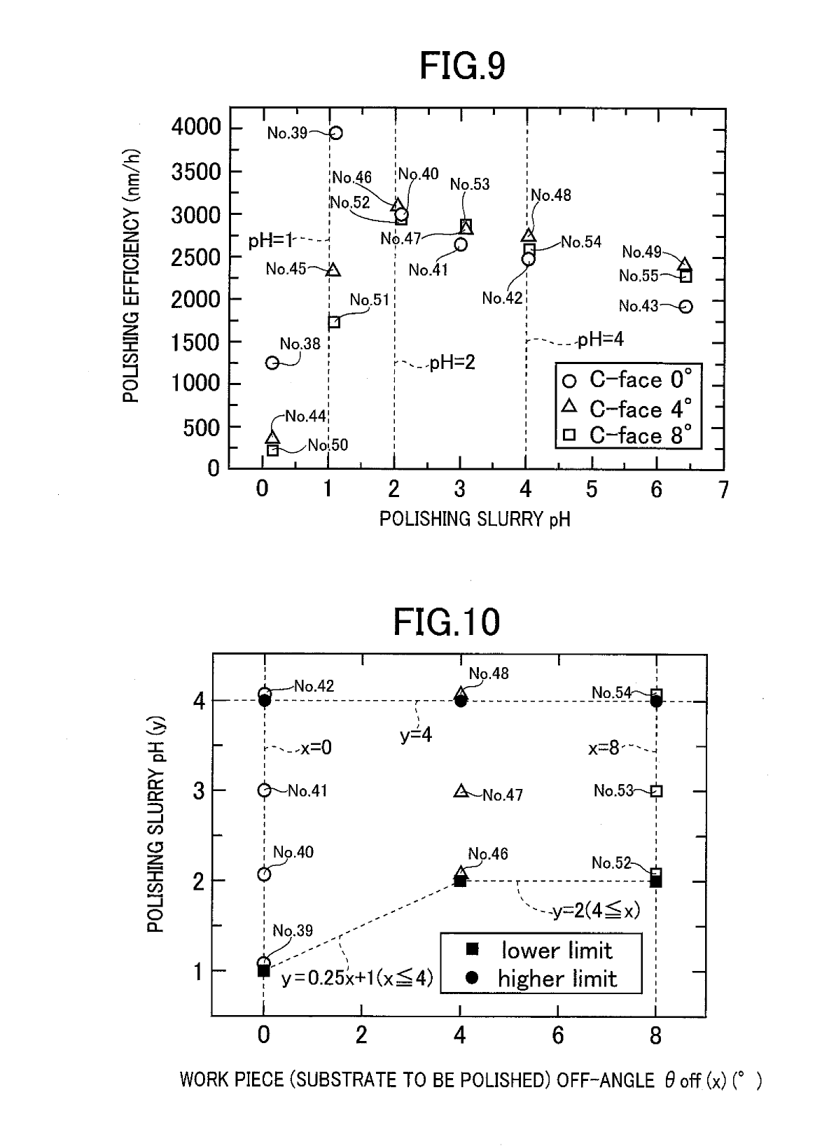

The results of the experiment III will hereinafter be described with reference to FIGS. 8 to 10. FIG. 8 is a diagram of polishing efficiency (nm/h) and surface roughness Ra (nm) from the polishing tests of Test Nos. 38 to 55. FIG. 9 is a diagram of the pH and polishing efficiency (nm/h) of the polishing slurries 10 of Test Nos. 38 to 55 shown in FIG. 8 each indicated by a point of a circle mark, a triangle mark, or a square mark in two-dimensional coordinates having the horizontal axis indicative of the pH of the polishing slurries 10 and the vertical axis indicative of the polishing efficiency (nm/h). It is noted that the point of the circle mark represents the polishing of the substrate to be polished 14 having the off-angle θoff of 0° relative to the (000-1)C plane, that the point of the triangle mark represents the polishing of the substrate to be polished 14 having the off-angle θoff of 4° relative to the (000-1)C plane, and that the point of the square mark represents the polishing of the substrate to be polished 14 having the off angle θoff of 8° relative to the (000-1)C plane. FIG. 10 is a diagram of the pH of the polishing slurries 10 and the off-angle θoff of Test Nos. 39 to 42, 46 to 48, and 52 to 54 each indicated by points in two-dimensional x-y coordinates having the x-axis (horizontal axis of FIG. 10) indicative of the off-angles θoff (°) of the substrates to be polished (work pieces) 14 relative to the (000-1)C plane and the y-axis (vertical axis of FIG. 10) indicative of the pH of the polishing slurries 10.

As shown in FIGS. 8 and 9 of the results of the experiment III, among Test Nos.

38 to 55, the polishing slurries 10 of Test Nos. 39 to 42, 46 to 48, and 52 to 54 resulted in processing of the substrate to be polished 14 with higher efficiency while maintaining relatively high processing accuracy. In the experiment III, the relatively high processing accuracy is the same as that of the experiment I, meaning that the surface roughness Ra of the substrate to be polished 14 after the polishing processing is about 0.3 nm or equal to or less than 0.3 nm. The higher efficiency means that, in the respective cases of using the substrates to be polished 14 having the off-angles θoff of 0°, 4°, and 8° relative to the (000-1)C plane, the polishing efficiency (nm/h) after the polishing processing is higher than the polishing efficiency (nm/h) of the polishing slurries 10 of Test Nos. 43, 49, and 55. Therefore, in the case of using the substrate to be polished 14 having the off-angle θoff of 0° relative to the (000-1)C plane, the higher efficiency means that the polishing efficiency (nm/h) after the polishing processing is higher than the polishing efficiency of 1951 (nm/h) of the polishing slurry 10 of Test No. 43; in the case of using the substrate to be polished 14 having the off-angle θoff of 4° relative to the (000-1)C plane, the higher efficiency means that the polishing efficiency (nm/h) after the polishing processing is higher than the polishing efficiency of 2407 (nm/h) of the polishing slurry 10 of Test No. 49; and in the case of using the substrate to be polished 14 having the off-angle θoff of 8° relative to the (000-1)C plane, the higher efficiency means that the polishing efficiency (nm/h) after the polishing processing is higher than the polishing efficiency of 2319 (nm/h) of the polishing slurry 10 of Test No. 55.

As shown in FIG. 10, with regard to the polishing slurries 10 of Test Nos. 39 to 42, 46 to 48, and 52 to 54 resulting in the processing of the substrate to be polished 14 with higher efficiency while maintaining relatively high processing accuracy, the relationship between the off-angle θoff (°) of the substrate to be polished 14 relative to the (000-1)C plane and the pH of the polishing slurry 10 is located within, or in the vicinity of, a range surrounded by four straight lines represented by y=4, y=0.25x+1(x≦4), y=2(4≦x), x=0, and x=8 in the two-dimensional x-y coordinates of the off-angle θoff (°) of the substrate to be polished 14 relative to the (000-1)C plane and the pH of the polishing slurry 10 indicated by x and y, respectively. The four straight lines described above, i.e., y=4, y=0.25x+1(x≦4), y=2(4≦x), x=0, and x=8, are determined from the points of black circle marks (higher limit) and the points of black square marks (lower limit) set by the present inventors based on the points corresponding to Test Nos. 39 to 42, 46 to 48, and 52 to 54 shown in FIG. 10. Although not shown, the polishing slurries 10 of Test Nos. 39 to 42, 46 to 48, and 52 to 54 have a relationship between the pH of the polishing slurries 10 and the oxidation-reduction potential (mV) of the polishing slurries 10 located within, or in the vicinity of, a range between two straight lines represented by z=−75y+1454 and z=−75y+1406 in the two-dimensional y-z coordinates of the pH of the polishing slurries 10 and the oxidation-reduction potential of the polishing slurries 10 indicated by y and z, respectively.

According to the results of the experiment III, the polishing slurries 10 of Test Nos. 39 to 42, 46 to 48, and 52 to 54 described above are located within, or in the vicinity of, the range surrounded by the four straight lines represented by y=4, y=0.25x+1(x≦4), y=2(4≦x), x=0, and x=8 in the two-dimensional x-y coordinates shown in FIG. 10. Therefore, it is considered that the polishing slurry 10 enables processing of the surface of the 4H-SiC single crystal used as the substrate to be polished 14 with higher efficiency while maintaining high processing accuracy, by setting the relationship between the off-angle θoff (°) of the substrate to be polished 14 relative to the (000-1)C plane and the pH of the polishing slurry 10 within the range surrounded by the four straight lines represented by y=4, y=0.25x+1(x≦4), y=2(4≦x), x=0, and x=8 in the two-dimensional x-y coordinates of the off-angle θoff (°) relative to the (000-1)C plane and the pH of the polishing slurry 10 indicated by x and y, respectively.

### [Experiment IV]

An experiment IV conducted by the present inventors will hereinafter be described. In the experiment IV, the silica abrasive grains used as the polishing particles contained in the polishing slurry 10 in the experiment I are changed to ceria (CeO₂) abrasive grains for verification of the effect on the substrate to be polished 14 during the polishing processing. The experiment IV is different from the experiment I in that the polishing particles contained in the polishing slurry 10 are ceria abrasive grains, and is substantially the same as the experiment I in terms of the other points.

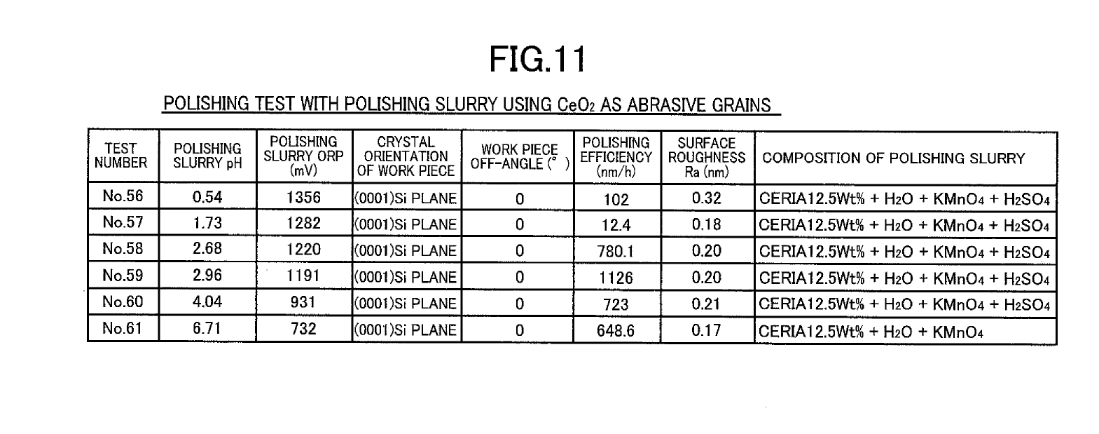

In the experiment IV, first, six types of the polishing slurries 10, i.e., the polishing slurries 10 of Test Nos. 56 to 61 were produced with the pH and the oxidation-reduction potential (ORP) adjusted to respective values as shown in FIG. 11, and each of these polishing slurries 10 was used for conducting a polishing test of the substrates to be polished 14 having the off-angle θoff of 0° relative to the (0001)Si plane for a predetermined time with the polishing processing conditions described in Table 1 described above. The ceria abrasive grains used as polishing particles contained in the polishing slurries 10 have the average particle diameter of about 800 nm. The average particle diameter of the ceria abrasive grains was obtained by using Mastersizer 2000 of Malvern Instruments with a laser diffraction method.

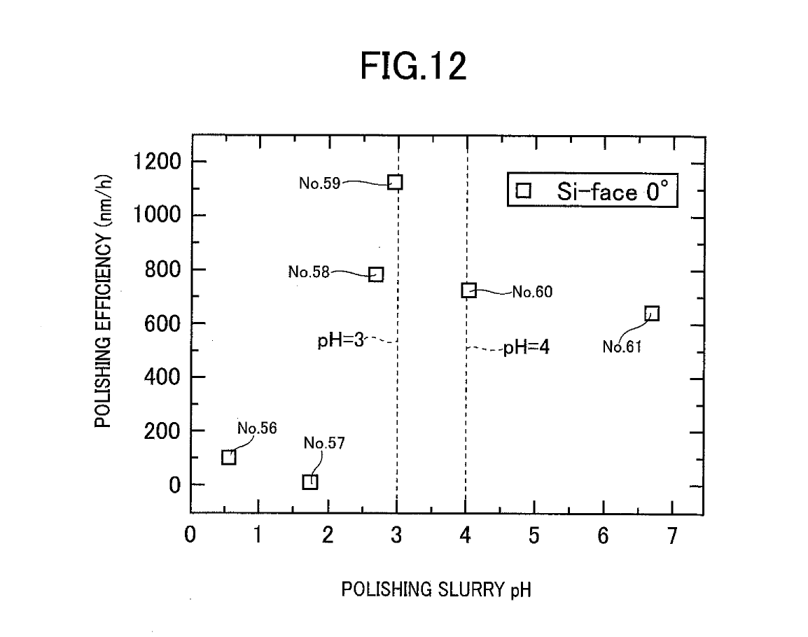

The results of the experiment IV will hereinafter be described with reference to FIGS. 11 and 12. FIG. 11 is a diagram of polishing efficiency (nm/h) and surface roughness Ra (nm) from the polishing tests of Test Nos. 56 to 61. FIG. 12 is a diagram of the pH and polishing efficiency (nm/h) of the polishing slurries 10 of Test Nos. 56 to 61 shown in FIG. 11 each indicated by a point of a square mark in two-dimensional coordinates having the horizontal axis indicative of the pH of the polishing slurries 10 and the vertical axis indicative of the polishing efficiency (nm/h).

As shown in FIG. 12 of the results of the experiment IV, among Test Nos. 56 to 61, the polishing slurries 10 of Test Nos. 58, 59, and 60 resulted in processing of the substrate to be polished 14 with higher efficiency while maintaining relatively high processing accuracy. In the experiment IV, the relatively high processing accuracy is the same as that of the experiment I, meaning that the surface roughness Ra of the substrate to be polished 14 after the polishing processing is about 0.3 nm or equal to or less than 0.3 nm. The higher efficiency means that the polishing efficiency after the polishing processing is higher than the polishing efficiency (648.6 nm/h) of the polishing slurry 10 of Test No. 61.

As shown in FIG. 12, with regard to the points of Test Nos. 58 to 60 resulting in the processing of the substrate to be polished 14 with higher efficiency while maintaining relatively high processing accuracy, the pH of the polishing slurry 10 is located within, or in the vicinity of, a range of 3 to 4. Although not shown, the polishing slurries 10 of Test Nos. 58 to 60 have a relationship between the pH of the polishing slurries 10 and the oxidation-reduction potential (mV) of the polishing slurries 10 located within, or in the vicinity of, a range between two straight lines represented by z=−75y+1454 and z=−75y+1406 in the two-dimensional y-z coordinates of the pH of the polishing slurries 10 and the oxidation-reduction potential of the polishing slurries 10 indicated by y and z, respectively.

According to the results of the experiment IV, the polishing slurries 10 containing the ceria (CeO₂) abrasive grains of Test Nos. 58 to 60 are located within, or in the vicinity of, the range surrounded by the four straight lines represented by y=4, y=3, z=−75y+1454, and z=−75y+1406 in the two-dimensional y-z coordinates in substantially the same way as the results of the experiment I, and these polishing slurries 10 render the processing with higher efficiency while maintaining relatively high processing accuracy. Therefore, it is considered that even when the polishing particles contained in the polishing slurry 10 are changed from the silica abrasive grains to the ceria abrasive grains, the polishing slurry 10 enables processing of the surface of the 4H-SiC single crystal used as the substrate to be polished 14 with higher efficiency while maintaining high processing accuracy, by setting the relationship between the pH of the polishing slurry 10 and the oxidation-reduction potential (mV) of the polishing slurry 10 within the range surrounded by the four straight lines represented by y=4, y=3, z=−75y+1454, and z−75y+1406 in the two-dimensional y-z coordinates of the pH of the polishing slurry 10 and the oxidation-reduction potential (mV) of the polishing slurry 10 indicated by y and z, respectively.

According to the polishing slurries 10 of Test Nos. 5 to 8, 14, 15, 29, 30, 35, 36, and 58 to 60 of this example, the polishing liquid contained in each polishing slurry 10 is an oxidizing polishing liquid, and the relationship between the pH of the polishing slurry 10 and the off-angle θoff of the 4H-SiC single crystal used as the substrate to be polished 14 relative to the (0001)Si plane is located within, or in the vicinity of, the range surrounded by the four straight lines represented by y=4, y=3, x=0, and x=8 in the two-dimensional x-y coordinates of the off-angle θoff and the pH of the polishing slurry 10 indicated by x and y, respectively. This polishing slurry 10 enables the processing of the surface of the SiC single crystal used as the substrate to be polished 14 with higher efficiency as compared to the conventional slurries while maintaining high processing accuracy.

According to the polishing slurries 10 of Test Nos. 39 to 42, 46 to 48, and 52 to 54 of this example, the polishing liquid contained in each polishing slurry 10 is an oxidizing polishing liquid, and the relationship between the pH of the polishing slurry 10 and the off-angle θoff of the 4H-SiC single crystal used as the substrate to be polished 14 relative to the (000-1)C plane is located within, or in the vicinity of, the range surrounded by the four straight lines represented by y=4, y=0.25x+1(x≦4), y=2(4≦x), x=0, and x=8 in the two-dimensional x-y coordinates of the off-angle θoff and the pH of the polishing slurry 10 indicated by x and y, respectively. This polishing slurry 10 enables the processing of the surface of the SiC single crystal used as the substrate to be polished 14 with higher efficiency as compared to the conventional slurries while maintaining high processing accuracy.

According to the polishing slurries 10 of Nos. 5 to 8, 14, 15, 29, 30, 35, 36, 39 to 42, 46 to 48, 52 to 54, and 58 to 60 of this example, the oxidation-reduction potential of each polishing slurry 10 is located within, or in the vicinity of, the range between the two straight lines represented by z=−75y+1454 and z=−75y+1406 in the two-dimensional y-z coordinates of the oxidation-reduction potential (mV) of the polishing slurry 10 indicated by z. This polishing slurry 10 enables the processing of the surface of the 4H-SiC single crystal used as the substrate to be polished 14 with higher efficiency.

According to the polishing slurries 10 of Nos. 5 to 8, 14, 15, 29, 30, 35, 36, 39 to 42, 46 to 48, 52 to 54, and 58 to 60 of this example, a potassium permanganate (KMnO₄) solution or a potassium thiosulfate (K₂S₂O₃) solution is added as a regulator for the oxidation-reduction potential of each polishing slurry 10. Therefore, by adding the potassium permanganate solution or the potassium thiosulfate solution, the oxidation-reduction potential of the polishing slurry 10 can preferably be adjusted into the range between the two straight lines represented by z=−75y+1454 and z=−75y+1406 described above, for example.

According to the polishing slurries 10 of Nos. 5 to 8, 14, 15, 29, 30, 35, 36, 39 to 42, 46 to 48, 52 to 54, and 58 to 60 of this example, the polishing particles contained in each polishing slurry 10 are silica (SiO₂) or ceria (CeO₂). Therefore, the polishing slurry 10 containing the polishing particles enables the processing of the surface of the 4H-SiC single crystal used as the substrate to be polished 14 with higher efficiency while maintaining high processing accuracy.

According to the polishing slurry 10 of Nos. 5 to 8, 14, 15, 29, 30, 35, 36, 39 to 42, 46 to 48, 52 to 54, and 58 to 60 of this example, the polishing slurry 10 is used in a polishing processing method of performing polishing processing of the substrate to be polished 14 made of a SiC single crystal material by using the polishing slurry 10. Therefore, the polishing processing method enables polishing of the substrate to be polished 14 made of the SiC single crystal material with relatively high efficiency while maintaining high processing accuracy.

Although the example of the present invention has been described in detail with reference to the drawings, the present invention is applied in other forms.

Although, for example, loose abrasive particles such as silica abrasive grains and ceria abrasive grains are used as the polishing particles of the polishing slurry 10, i.e., a polishing composition in this example, the polishing particles are not limited to the loose abrasive particles and may be used as bonded abrasive particles, for example. Therefore, the polishing composition is not necessarily limited to the polishing slurry 10.

Although the polishing slurry 10 of this example has silica and ceria used for the polishing particles of the polishing slurry 10, the polishing particles are not limited to silica and ceria. For example, the polishing particles may contain at least one of silica, ceria, alumina, zirconia, titania, manganese oxide, barium carbonate, chromium oxide, and iron oxide.

Although sulfuric acid and potassium hydroxide are used for the polishing slurry 10 of this example as the pH regulator for the pH of the polishing slurry 10, for example, hydrochloric acid, nitric acid, and sodium hydroxide may also be used.

The above description is merely an embodiment and the present invention may be implemented in variously modified and improved forms based on the knowledge of those skilled in the art.

### NOMENCLATURE OF ELEMENTS

10: polishing slurry (polishing composition)

14: substrate to be polished (object to be polished)

θoff : off-angle

1-6. (canceled)

7. A polishing composition containing polishing particles and a polishing liquid used in polishing processing for smoothing a (0001)Si plane of a SiC single crystal used as an object to be polished,
the polishing liquid being an oxidizing polishing liquid, and a relationship between pH of the polishing composition and an off-angle of the (0001)Si plane of the SiC single crystal being located within a range surrounded by four straight lines represented by following equations (1), (2), (3), and (4) in two-dimensional x-y coordinates where the off-angle (°) and the pH of the polishing composition are indicated by x and y, respectively:
y=4 (1);
y=3 (2);
x=0 (3); and
x=8 (4).

8. A polishing composition containing polishing particles and a polishing liquid used in polishing processing for smoothing a (000-1)C plane of a SiC single crystal used as an object to be polished,
the polishing liquid being an oxidizing polishing liquid, and a relationship between pH of the polishing composition and an off-angle of the (000-1)C plane of the SiC single crystal being located within a range surrounded by five straight lines represented by following equations (1), (5), (3), and (4) in two-dimensional x-y coordinates where the off-angle (°) and the pH of the polishing composition are indicated by x and y, respectively:
y=4 (1);
y=0.25x+1(x≦4), y=2(4≦x) (5);
x=0 (3); and
x=8 (4).

9. The polishing composition according to claim 7, wherein oxidation-reduction potential of the oxidizing polishing liquid is located within a range between two straight lines represented by following equations (6) and (7) in two-dimensional y-z coordinates where the oxidation-reduction potential (mV) of the polishing liquid is indicated by z:
z=−75y+1454 (6); and
z=−75y+1406 (7).

10. The polishing composition according to claim 8, wherein oxidation-reduction potential of the oxidizing polishing liquid is located within a range between two straight lines represented by following equations (6) and (7) in two-dimensional y-z coordinates where the oxidation-reduction potential (mV) of the polishing liquid is indicated by z:
z=−75y+1454 (6); and
z=−75y+1406 (7).

11. The polishing composition according to claim 9, wherein potassium permanganate or potassium thiosulfate is added as a regulator for an oxidation-reduction potential of the oxidizing polishing liquid.

12. The polishing composition according to claim 10, wherein potassium permanganate or potassium thiosulfate is added as a regulator for an oxidation-reduction potential of the oxidizing polishing liquid.

13. The polishing composition according to claim 7, wherein the polishing particles contain at least one of silica, ceria, alumina, zirconia, titania, manganese oxide, barium carbonate, chromium oxide, and iron oxide.

14. The polishing composition according to claim 8, wherein the polishing particles contain at least one of silica, ceria, alumina, zirconia, titania, manganese oxide, barium carbonate, chromium oxide, and iron oxide.

15. A polishing processing method, wherein polishing processing of a SiC single crystal material is performed by using the polishing composition according to claim 7.

16. A polishing processing method, wherein polishing processing of a SiC single crystal material is performed by using the polishing composition according to claim 8.
